(19) United States
(12) Patent Application Publication
(10) Pub. No.: US 2025/0096688 A1
(43) Pub. Date: Mar. 20, 2025

(54) MULTIPHASE POWER SUPPLY WITH IMPROVED TRANSIENT RESPONSE

(71) Applicant: Chengdu Monolithic Power Systems Co., Ltd., Chengdu (CN)

(72) Inventor: Lei Li, Chengdu (CN)

(21) Appl. No.: 18/890,604

(22) Filed: Sep. 19, 2024

(30) Foreign Application Priority Data
Sep. 20, 2023 (CN) 202311222180.3

(51) Int. Cl. H02M 3/158; H02M 3/157

(52) U.S. Cl. CPC H02M 3/1584; H02M 3/157

(57) ABSTRACT

A multiphase power supply with improved transient response discussed. The multiphase power supply has n voltage converters coupled in parallel between in input voltage and an output voltage. Each voltage converter includes a power circuit and a control circuit. The control circuit is configured to generate a control signal in response to a current sense signal indicative of a real time current flowing through the power converter and an average current signal indicative of an average current flowing through all of the voltage converters.

### CROSS-REFERENCE TO RELATED APPLICATIONS

This application claims priority to and the benefit of Chinese Patent Application No. 202311222180.3, filed Sep. 20, 2023, which is incorporated herein by reference in its entirety.

### BACKGROUND OF THE INVENTION

A DC-DC converter typically converts an input voltage to an output voltage, which is higher than the input voltage in the case of a boost converter or lower than the input voltage in the case of a buck converter. Several DC-DC converters may be employed together to form a multiphase power supply, with each DC-DC converter providing a different output voltage or a different output current at different phases.

In the multiphase power supply, the constant on time control and the fix frequency peak current control are two commonly used control schemes. However, the fix frequency peak current control may affect the performance of the DC-DC converter due to its narrow bandwidth, which slows the transient response.

### SUMMARY OF THE INVENTION

In accordance with an embodiment of the present invention, a multiphase power supply is discussed. The multiphase power supply comprises n voltage converters coupled in parallel between an input voltage and an output voltage. N is an integer larger than zero. Each of the voltage converters includes a power circuit and a control circuit. Each control circuit comprises: an error amplifier and a comparison logical circuit. The error amplifier is configured to generate an error signal in response to a feedback voltage indicative of the output voltage, an average current signal indicative of an average current flowing through all of the voltage converters, and a current sense signal indicative of a real time current flowing through a corresponding power circuit of the control circuit. The comparison logical circuit is configured to generate a control signal in response to the error signal and a clock signal, to control the power circuit.

In addition, in accordance with an embodiment of the present invention, a multiphase power supply is discussed. The multiphase power supply comprises a voltage converter and a control circuit. The voltage converter has a power circuit configured to receive an input voltage and provide an output voltage. The control circuit is configured to generate a control signal in response to a feedback voltage indicative of the output voltage, an average current signal indicative of an average current flowing through the power circuit in a switching cycle, a current sense signal indicative of a real time current flowing through the power converter, and a clock signal, to control the power circuit.

Furthermore, in accordance with an embodiment of the present invention, a multiphase power supply is discussed. The multiphase power supply comprises: a controller die and a power circuit including a first power switch die and a second power switch die. The first power switch die is configured to receive an input voltage. The second power switch die is coupled to the first power switch die. The controller die is configured to receive both an average current signal indicative of an average current flowing through the power circuit in a switching cycle, and a current sense signal indicative of a real time current flowing through the power circuit, to generate a control signal to control the first power switch die. The first power switch die is configured to provide a PWM signal to control the second power switch die in response to the control signal.

### BRIEF DESCRIPTION OF DRAWINGS

FIG. 1 schematically shows a multiphase power supply 100 in accordance with an embodiment of the present invention.

FIG. 2 schematically shows a circuit configuration (e.g., 2001) of the control circuit in accordance with an embodiment of the present invention.

FIG. 3 schematically shows another circuit configuration of the control circuit (e.g., 2001) in accordance with an embodiment of the present invention.

FIG. 4 schematically shows yet another circuit configuration of the control circuit (e.g., 2001) in accordance with an embodiment of the present invention.

FIG. 5 schematically shows a multiphase power supply 500 in accordance with an embodiment of the present invention.

FIG. 6 schematically shows a circuit configuration of the comparison logical circuit 12 in accordance with an embodiment of the present invention.

FIG. 7 schematically shows a flowchart 700 of a method used in a multiphase power supply in accordance with an embodiment of the present invention.

FIG. 8 schematically shows a multiphase power supply 800 in accordance with an embodiment of the present invention

### DETAILED DESCRIPTION OF THE INVENTION

Embodiments of circuits for multiphase power supply are described in detail herein. In the following description, some specific details, such as example circuits for these circuit components, are included to provide a thorough understanding of embodiments of the invention. One skilled in relevant art will recognize, however, that the invention can be practiced without one or more specific details, or with other methods, components, materials, etc.

The following embodiments and aspects are illustrated in conjunction with circuits and methods that are meant to be exemplary and illustrative. In various embodiments, the above problem has been reduced or eliminated, while other embodiments are directed to other improvements.

FIG. 1 schematically shows a multiphase power supply 100 in accordance with an embodiment of the present invention. In the example of FIG. 1, the multiphase power supply 100 comprises: n voltage converters 101, . . . , and 10n, coupled in parallel between an input voltage Vᵢₙ and an output voltage V_{O}, wherein n is an integer larger than 0. That is, each of the voltage converters acts a single phase of the power supply, and is configured to convert the input voltage Vᵢₙ to the output voltage V_{O}. Each of the voltage converters includes a power circuit (e.g. 1001, . . . , and 100n) and a control circuit (e.g. 2001, . . . , and 200n). Each power circuit comprises a power switch. Each control circuit comprises: an error amplifier 11, configured to amplify a difference between a) a sum of a feedback voltage V_{FB} and an average current signal I_{SUM} and b) a sum of a current sense signal (e.g., I_{CS1}, . . . , and I_{CSn}) and a voltage reference V_{REF}, to generate an error signal EAO. The feedback voltage V_{FB} is indicative of the output voltage V_{O}. The average current signal I_{SUM} is indicative of an average current flowing through all of the voltage converters. The current sense signal is indicative of a current flowing through a corresponding power circuit of the control circuit. The corresponding power circuit of the control circuit means that the power circuit and the control circuit are in a same voltage converter. For example, the power circuit 1001 is the corresponding power circuit of the control circuit 2001, and the power circuit 100n is the corresponding power circuit of the control circuit 200n. The control circuit further comprises: a comparison logical circuit 12, configured to generate a control signal ctrl in response to the error signal EAO and a clock signal clk, to control the power circuit (e.g., 1001, . . . , and 100n).

In one embodiment of the present invention, the average current flowing through all of the voltage converters multiplied by a number of the phases is a total current (i.e. a sum current) flowing through all of the voltage converters.

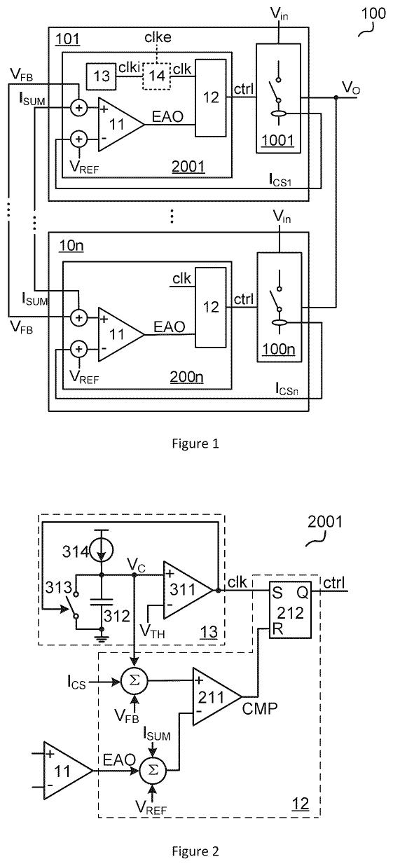

In the example of FIG. 1, the control circuit 2001 acts as a master controller, and the others acts as slave controller. The control circuit 2001 (i.e., the master controller) further comprises: an oscillation circuit 13, configured to generate an internal clock signal clki. The internal clock signal clki may be directly delivered to the comparison logical circuit 12 to be used as the clock signal. However, one skilled in the art should realize that the control circuit may also receive an external clock signal (as shown the dashed line in FIG. 1). As shown in FIG. 2, the control circuit may be also configured to receive an external clock signal clke, and to process the external clock with the internal clock signal (e.g., to perform a phase lock operation on the external clock signal and the internal clock signal) by way of a clock process circuit 14, to generate the clock signal clk. The master controller may output the clock signal clk to slave controllers, i.e., the master controller may provide the clock signal clk to other voltage converters, to synchronize the clock frequency of all the voltage converters. The slave controller may shift the phase of the clock signal upon the receipt of the clock signal. In one embodiment of the present invention, each phase of the power supply has a clock signal with a phase shift of 360/n degrees with the adjacent phase. For example, in a three-phase power supply, the phase shift between each phase is 120 degrees.

FIG. 2 schematically shows a circuit configuration (e.g., 2001) of the control circuit in accordance with an embodiment of the present invention. The example in FIG. 2 schematically shows the circuit configurations of the comparison logical circuit 12 and the oscillation circuit 13. Specifically, in the example of FIG. 2, the oscillation circuit 13 comprises: a sawtooth wave comparator 311, having a first input terminal and a second input terminal. The first input terminal is configured to receive a voltage threshold V_{TH}. A capacitor 312 and a reset switch 313 are coupled in parallel between the second input terminal and a reference ground. The oscillation circuit 13 further comprises: a current source 314, configured to charge the capacitor 312. The sawtooth wave comparator 311 is configured to compare a voltage drop V_{C} across the capacitor 312 with the voltage threshold V_{TH}, to generate the clock signal clk. When the voltage drop V_{C} across the capacitor 312 reaches the voltage threshold V_{TH}, the clock signal clk jumps high, causing the reset switch 313 to be turned on. Accordingly, the voltage drop across the capacitor 312 is reset to zero. Then the clock signal clk jumps low, causing the reset switch 313 to be turned off. The current source 314 is configured to recharge the capacitor 312, and the voltage drop V_{C} across the capacitor 312 increases from zero again. Thus, the voltage drop V_{C} across the capacitor 312 presents as a sawtooth waveform. The comparison logical circuit 12 comprises: a comparison circuit 211, configured to compare a) a sum of the feedback voltage V_{FB}, the voltage drop V_{C} across the capacitor 312 and the current sense signal I_{CS} with b) a sum of the average current signal I_{SUM}, the voltage reference V_{REF} and the error signal EAO, to generate a comparison signal CMP; and a logical circuit 212, configured to be set by the clock signal clk, and to be reset by the comparison signal clk, to generate the control signal ctrl, to control the power circuit (e.g., 1001).

In the example of FIG. 2, the logical circuit 212 comprises a flip flop.

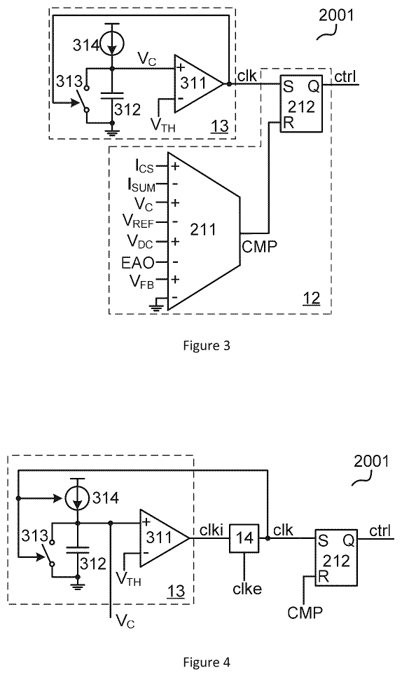

FIG. 3 schematically shows another circuit configuration of the control circuit (e.g., 2001) in accordance with an embodiment of the present invention. The example in FIG. 3 also schematically shows the circuit configurations of the comparison logical circuit 12 and the oscillation circuit 13. Compared to the example of FIG. 2, in the example of FIG. 3, a DC offset V_{DC} is added to the comparison circuit 211. Specifically, in the example of FIG. 3, the comparison circuit 211 is configured to compare a) a sum of the feedback voltage V_{FB}, the voltage drop V_{C} across the capacitor 312, the DC offset V_{DC}, and the current sense signal I_{CS} with b) the sum of the average current signal I_{SUM}, the voltage reference V_{REF} and the error signal EAO, to generate the comparison signal CMP.

In one embodiment of the present invention, the power circuit comprises a buck circuit.

FIG. 4 schematically shows yet another circuit configuration of the control circuit (e.g., 2001) in accordance with an embodiment of the present invention. In the example of FIG. 4, the control circuit is configured to receive an external clock signal clke, and configured to process the external clock signal clke with the internal clock signal clki, to generate the clock signal clk. At the oscillation circuit 13, the current source 314 is controlled by the clock signal clk, to provide a corresponding charge current to the capacitor 312, so that the oscillation circuit generates the corresponding sawtooth waveform V_{C}.

FIG. 5 schematically shows a multiphase power supply 500 in accordance with an embodiment of the present invention. In the example of FIG. 5, the multiphase power supply 500 comprises one voltage converter. That is, n=1. The voltage converter comprises a power circuit. Specifically, the power circuit comprises: a first power switch S1 and a second power switch S2, series coupled between an input voltage Vᵢₙ and a reference ground. An electrical connection of the first power switch S1 and the second power switch S2 forms a switch node SW. The voltage converter further comprises: an inductor L, coupled between the switch node SW and an output voltage V_{O}; and an output capacitor C, coupled between the output voltage V_{O} and the reference ground. The voltage converter further comprises: an error amplifier 11, an oscillation circuit 13, a comparison circuit 211, and a logical circuit 213. The error amplifier 11 is configured to amplify a difference between a) a sum of a feedback voltage V_{FB} indicative of the output voltage V_{O} and an average current signal I_{SUM} indicative of an average current flowing through the inductor L in a switching cycle and b) a sum of a current sense signal I_{CS} indicative of a real time current flowing through the inductor L and a voltage reference V_{REF}, to generate an error signal EAO. The oscillation circuit 13 is configured to provide a sawtooth wave signal V_{C} and a clock signal clk. The comparison circuit 211 is configured to compare a) a sum of the feedback voltage V_{FB}, the sawtooth wave signal V_{C} and the current sense signal I_{CS} with b) a sum of the average current signal I_{SUM}, the voltage reference V_{REF} and the error signal EAO, to generate a comparison signal CMP. The logical circuit 213 is configured to be set in response to the clock signal clk, and to be reset in response to the comparison signal CMP, to generate a control signal ctrl, to control the first power switch S1 and the second power switch S2.

In the example of FIG. 5, the voltage converter further comprises: a drive circuit 15, configured to generate a first drive signal G_{S1} and a second drive signal G_{S2} in response to the control signal ctrl, to respectively control the first power switch S1 and the second power switch S2.

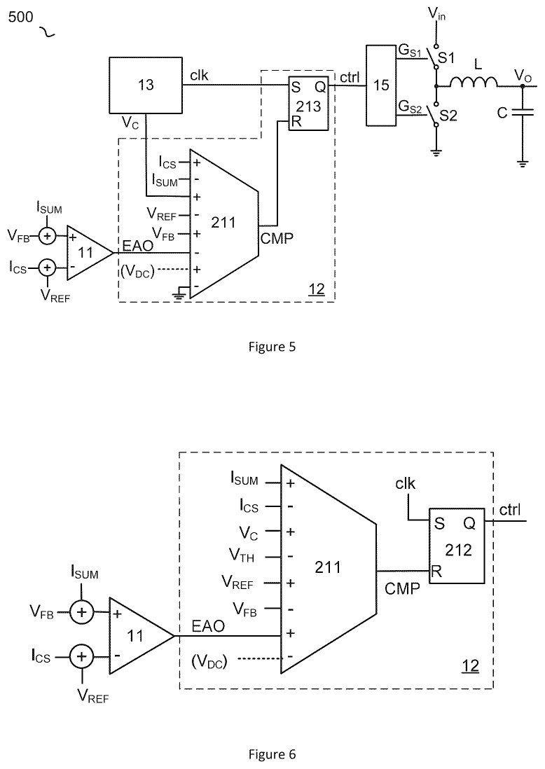

The comparison circuit 211 in the foregoing embodiments of the multiphase power supply performs peak voltage mode control. However, one skilled in the art should realize that the comparison circuit 211 may also perform valley voltage mode control. As shown in FIG. 6 below.

FIG. 6 schematically shows a circuit configuration of the comparison logical circuit 12 in accordance with an embodiment of the present invention. In the example of FIG. 6, the comparison circuit 211 is configured to compare a) a sum of the feedback voltage V_{FB}, the voltage threshold V_{TH}, the DC offset V_{DC}, and the current sense signal I_{CS} with b) a sum of the average current signal I_{SUM}, the voltage reference V_{REF}, the sawtooth wave signal V_{C}, and the error signal EAO, to generate the comparison signal CMP. Other circuit parts of the comparison circuit 211 in the example of FIG. 6 is similar to those in the previous embodiments.

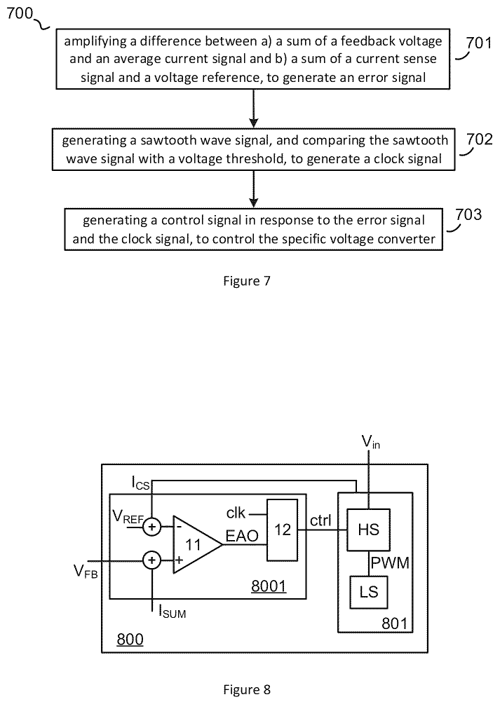

FIG. 7 schematically shows a flowchart 700 of a method used in a multiphase power supply in accordance with an embodiment of the present invention. The multiphase power supply comprises n voltage converters coupled in parallel. All of the voltage converters are configured to receive an input voltage and to generate an output voltage. N is an integer larger than zero. The method comprises:

Step 701, amplifying a difference between a) a sum of a feedback voltage and an average current signal and b) a sum of a current sense signal and a voltage reference, to generate an error signal. The feedback voltage is indicative of the output voltage. The average current signal is indicative of an average current flowing through all of the voltage converters. The current sense signal is indicative of a current flowing through one specific voltage converter.

Step 702, generating a sawtooth wave signal, and comparing the sawtooth wave signal with a voltage threshold, to generate a clock signal. And

Step 703, generating a control signal in response to the error signal and the clock signal, to control the specific voltage converter.

In one embodiment of the present invention, the step generating the control signal in response to the error signal and the clock signal comprises: comparing a) a sum of the feedback voltage, the sawtooth wave signal, and the current sense signal with b) a sum of the average current signal, the voltage reference, and the error signal, to generate a comparison signal; and getting set in response to the clock signal and reset in response to the comparison signal, to generate the control signal.

In one embodiment of the present invention, the step generating the control signal in response to the error signal and the clock signal comprises: comparing a) a sum of the feedback voltage, the sawtooth wave signal, a DC offset and the current sense signal with b) the sum of the average current signal, the voltage reference, and the error signal, to generate the comparison signal; and getting set in response to the clock signal and reset in response to the comparison signal, to generate the control signal.

In one embodiment of the present invention, the step generating the control signal in response to the error signal and the clock signal comprises: comparing a) a sum of the feedback voltage, a voltage threshold, a DC offset and the current sense signal with b) a sum of the average current signal, the sawtooth wave signal, the voltage reference, and the error signal, to generate the comparison signal; and getting set in response to the clock signal and reset in response to the comparison signal, to generate the control signal.

FIG. 8 schematically shows a multiphase power supply 800 in accordance with an embodiment of the present invention. In the example of FIG. 8, the multiphase power supply 800 comprises: a power circuit 801, having a first power switch die HS and a second power switch die LS. The first power switch die HS is configured to receive an input voltage Vᵢₙ, and the second power switch die LS is coupled to the first power switch die HS. The multiphase power supply further comprises: a controller die 8001, configured to receive both an average current signal I_{SUM} indicative of an average current flowing through the power circuit 801 in a switching cycle, and a current sense signal I_{CS} indicative of a real time current flowing through the power circuit 801, to generate a control signal to control the first power switch die. The first power switch die HS is configured to provide a PWM signal to control the second power switch die LS in response to the control signal ctrl.

In the example of FIG. 8, the controller die 8001 comprises: an error amplifier 11, configured to generate an error signal EAO in response to a feedback voltage V_{FB}, the average current signal I_{SUM}, and the current sense signal ICS; and a comparison logical circuit 12, configured to generate the control signal ctrl in response to the error signal EAO and a clock signal clk, to control the power circuit 801.

Specifically, the error amplifier 11 may amplify a difference between a) a sum of the feedback voltage V_{FB} and the average current signal I_{SUM} and b) a sum of the current sense signal (e.g., I_{CS1}, . . . , and I_{CSn}) and a voltage reference V_{REF}, to generate the error signal EAO, as discussed hereinbefore.

The comparison logical circuit 12 in the multiphase power supply 800 may have similar circuit configurations as the comparison logical circuits 12 in the example of FIG. 2, FIG. 3, and FIG. 5.

The example in FIG. 8 shows that the multiphase power supply 800 only comprises one voltage converter. But one skilled in the art should realize that the multiphase power supply may comprise more than one voltage converters coupled in parallel, as shown in FIG. 1.

Several embodiments of the foregoing multiphase power supply and the method feed the current information of both the current flowing through a specific power circuit and the average current flowing through all of the power circuits back to the error amplifier, to add the current information to the feedback voltage, so as to reduce the influence caused by load change. Thus, the system bandwidth is increased, and the transient response is improved. Furthermore, the current flowing through one specific power circuit, the average current flowing through all of the power circuits, the sawtooth wave signal, the feedback voltage and the error signal are compared at the comparison circuit, to generate a comparison signal which is used to set the control signal, causing the control loop to work as a voltage mode. But due to the feedback of the current information, the control loop is easily to be compensated.

It is to be understood in these letters patent that the meaning of “A” is coupled to “B” is that either A and B are connected to each other as described below, or that, although A and B may not be connected to each other as described above, there is nevertheless a device or circuit that is connected to both A and B. This device or circuit may include active or passive circuit elements, where the passive circuit elements may be distributed or lumped-parameter in nature. For example, A may be connected to a circuit element that in turn is connected to B.

This written description uses examples to disclose the invention, including the best mode, and also to enable a person skilled in the art to make and use the invention. The patentable scope of the invention may include other examples that occur to those skilled in the art.

1. A multiphase power supply, comprising:
n voltage converters, coupled in parallel between an input voltage and an output voltage, wherein n is an integer larger than zero, and wherein each of the voltage converters includes a power circuit and a control circuit, each control circuit comprises:
an error amplifier, configured to generate an error signal in response to a feedback voltage indicative of the output voltage, an average current signal indicative of an average current flowing through all of the voltage converters, and a current sense signal indicative of a real time current flowing through a corresponding power circuit of the control circuit; and
a comparison logical circuit, configured to generate a control signal in response to the error signal and a clock signal, to control the power circuit.

2. The multiphase power supply of claim 1, wherein
the error amplifier is configured to amplify a difference between a) a sum of the feedback voltage and the average current signal and b) a sum of the current sense signal and a voltage reference, to generate the error signal.

3. The multiphase power supply of claim 1, wherein the comparison logical circuit comprises:
a comparison circuit, configured to compare a) a sum of the feedback voltage, a sawtooth waveform, and the current sense signal with b) a sum of the average current signal, a voltage reference, and the error signal, to generate a comparison signal; and
a logical circuit, configured to be set by the clock signal, and to be reset by the comparison signal, to generate the control signal, to control the power circuit.

4. The multiphase power supply claim 1, wherein the comparison logical circuit comprises:
a comparison circuit, configured to compare a) a sum of the feedback voltage, a sawtooth waveform, a DC offset, and the current sense signal with b) a sum of the average current signal, a voltage reference, and the error signal, to generate a comparison signal; and
a logical circuit, configured to be set by the clock signal, and to be reset by the comparison signal, to generate the control signal, to control the power circuit.

5. The multiphase power supply of claim 1, wherein the comparison logical circuit comprises:
a comparison circuit, configured to compare a) a sum of the feedback voltage, a voltage threshold, a DC offset, and the current sense signal with b) a sum of the average current signal, a sawtooth waveform, a voltage reference, and the error signal, to generate a comparison signal; and
a logical circuit, configured to be set by the clock signal, and to be reset by the comparison signal, to generate the control signal, to control the power circuit.

6. The multiphase power supply of claim 1, wherein one of the control circuits acts as a master controller, and the others acts as slave controllers, and wherein the master controller comprises:
an oscillation circuit, configured to generate the clock signal and delivered the clock signal to the slave controllers.

7. The multiphase power supply of claim 1, wherein one of the control circuits acts as a master controller, and the others acts as slave controllers, and wherein the master controller comprises:
an oscillation circuit, configured to generate an internal clock signal; and
a clock process circuit, configured to perform a phase lock operation on the internal clock signal and an external clock signal, to generate the clock signal and delivered the clock signal to the slave controllers.

8. A multiphase power supply, comprising:
a voltage converter having a power circuit configured to receive an input voltage and provide an output voltage; and
a control circuit, configured to generate a control signal in response to a feedback voltage indicative of the output voltage, an average current signal indicative of an average current flowing through the power circuit in a switching cycle, a current sense signal indicative of a real time current flowing through the power converter, and a clock signal, to control the power circuit.

9. The multiphase power supply claim 8, wherein the control circuit comprises:
an error amplifier, configured to amplify a difference between a) a sum of the feedback voltage and the average current signal and b) a sum of the current sense signal and a voltage reference, to generate an error signal; and
a comparison logical circuit, configured to generate the control signal in response to the error signal and the clock signal.

10. The multiphase power supply claim 9, wherein the comparison logical circuit comprises:
a comparison circuit, configured to compare a) a sum of the feedback voltage, a sawtooth wave signal and the current sense signal with b) a sum of the average current signal, the voltage reference and the error signal, to generate a comparison signal; and
a logical circuit, configured to be set in response to the clock signal, and to be reset in response to the comparison signal, to generate the control signal.

11. The multiphase power supply of claim 9, wherein the comparison logical circuit comprises:
a comparison circuit, configured to compare a) a sum of the feedback voltage, a sawtooth waveform, a DC offset, and the current sense signal with b) a sum of the average current signal, the voltage reference, and the error signal, to generate a comparison signal; and
a logical circuit, configured to be set by the clock signal, and to be reset by the comparison signal, to generate the control signal.

12. The multiphase power supply of claim 9, wherein the comparison logical circuit comprises:
a comparison circuit, configured to compare a) a sum of the feedback voltage, a voltage threshold, a DC offset, and the current sense signal with b) a sum of the average current signal, a sawtooth waveform, the voltage reference, and the error signal, to generate a comparison signal; and
a logical circuit, configured to be set by the clock signal, and to be reset by the comparison signal, to generate the control signal, to control the power circuit.

13. The multiphase power supply of claim 8, further comprising:
an oscillation circuit, configured to generate an internal clock signal; and
a clock process circuit, configured to perform a phase lock operation on the internal clock signal and an external clock signal, to generate the clock signal.

14. A multiphase power supply, comprising:
a power circuit including a first power switch die and a second power switch die, wherein the first power switch die is configured to receive an input voltage, and the second power switch die is coupled to the first power switch die; and
a controller die, configured to receive both an average current signal indicative of an average current flowing through the power circuit in a switching cycle, and a current sense signal indicative of a real time current flowing through the power circuit, to generate a control signal to control the first power switch die; wherein
the first power switch die is configured to provide a PWM signal to control the second power switch die in response to the control signal.

15. The multiphase power supply of claim 14, wherein the controller die comprises:
an error amplifier, configured to generate an error signal in response to a feedback voltage, the average current signal, and the current sense signal; and
a comparison logical circuit, configured to generate the control signal in response to the error signal and a clock signal, to control the power circuit.

16. The multiphase power supply of claim 15, wherein the comparison logical circuit comprises:
a comparison circuit, configured to compare a) a sum of the feedback voltage, a sawtooth waveform, and the current sense signal with b) a sum of the average current signal, a voltage reference, and the error signal, to generate a comparison signal; and
a logical circuit, configured to be set by the clock signal, and to be reset by the comparison signal, to generate the control signal, to control the power circuit.

17. The multiphase power supply claim 15, wherein the comparison logical circuit comprises:
a comparison circuit, configured to compare a) a sum of the feedback voltage, a sawtooth waveform, a DC offset, and the current sense signal with b) a sum of the average current signal, a voltage reference, and the error signal, to generate a comparison signal; and
a logical circuit, configured to be set by the clock signal, and to be reset by the comparison signal, to generate the control signal, to control the power circuit.

18. The multiphase power supply of claim 15, wherein the comparison logical circuit comprises:
a comparison circuit, configured to compare a) a sum of the feedback voltage, a voltage threshold, a DC offset, and the current sense signal with b) a sum of the average current signal, a sawtooth waveform, a voltage reference, and the error signal, to generate a comparison signal; and
a logical circuit, configured to be set by the clock signal, and to be reset by the comparison signal, to generate the control signal, to control the power circuit.

19. The multiphase power supply of claim 14, the controller die comprises:
an oscillation circuit, configured to generate an internal clock signal; and
a clock process circuit, configured to perform a phase lock operation on the internal clock signal and an external clock signal, to generate the clock signal.
